(19) United States
(12) Patent Application Publication
(10) Pub. No.: US 2021/0101307 A1
(43) Pub. Date: Apr. 8, 2021

(54) HELICAL CUTTING TOOL

(71) Applicant: OSI MACHINERIE INC., Saint-Georges (CA)

(72) Inventor: André LAPOINTE, Saint-Simon-Les-Mines (CA)

(21) Appl. No.: 17/061,772

(22) Filed: Oct. 2, 2020

Related U.S. Application Data
(60) Provisional application No. 62/910,512, filed on Oct. 4, 2019.

(51) Int. Cl. B27G 13/04; B27C 1/14

(52) U.S. Cl. CPC B27G 13/04; B27C 1/14

(57) ABSTRACT

A cylindrical cutting head for a wood workpiece, comprising an even number of main grooves disposed on helices running on a length of a surface thereof, wherein each main groove comprises cutting inserts; each cutting insert comprising a knife removably locked in position in relation to the main groove by a clamp. A cutting insert for a cylindrical cutting head for a wood workpiece, comprising a knife and a clamp, wherein the knife is removably positioned and locked in position in relation to the cylindrical cutting head by a clamp.

### CROSS REFERENCE TO RELATED APPLICATIONS

This application claims benefit of U.S. provisional application Ser. No. 62/910,512, filed on Oct. 4, 2019,

### FIELD OF THE INVENTION

The present invention relates to rotary cutting tool. More specifically, the present invention is concerned with a helical cutting tool for woodworking machines.

### BACKGROUND OF THE INVENTION

Helical cutting tools are used in woodworking, for example in planers. Typically, a rotary body comprises a plurality of cutting inserts. Each insert comprises a carbide blade, mounted to the rotary body by welding as shown in FIG. 1, or clamped on the rotary body for example.

Although a number of developments have been proposed in the art, sharpening of helical cutting tools remains complex. Moreover, usable components thereof are oftentimes not efficiently removable and replaceable, causing time delays and component costs.

There is still a need in the art for a helical cutting tool.

### SUMMARY OF THE INVENTION

More specifically, in accordance with the present invention, there is provided a cylindrical cutting head for a wood workpiece, comprising an even number of main grooves disposed on helices running on a length of a surface thereof, wherein each main groove comprises cutting inserts; each cutting insert comprising a knife removably locked in position in relation to the main groove by a clamp

There is further provided a cutting insert for a cylindrical cutting head for a wood workpiece, comprising a knife and a clamp, wherein the knife is removably positioned and locked in position in relation to the cylindrical cutting head by a clamp.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a cutting insert for a helical cutting tool as known in the art;

FIG. 2 is an isometric view of a cutting head according to an embodiment of an aspect of the present disclosure;

FIG. 3 shows a detail of a cutting head according to an embodiment of an aspect of the present disclosure;

FIG. 4 is a cross section view of a cutting head according to an embodiment of an aspect of the present disclosure;

FIG. 5A is an isometric view of a knife according to an embodiment of an aspect of the present disclosure;

FIG. 5B is a cut section view of the knife of FIG. 5A;

FIG. 6A is an isometric view of a sharpening guide according to an embodiment of an aspect of the present disclosure;

FIG. 6B is an isometric view of a sharpening guide according to an embodiment of an aspect of the present disclosure;

FIG. 7 is a general view of a system for grinding knifes of a cutting head according to an embodiment of an aspect of the present disclosure;

FIG. 8 is a side view of the system of FIG. 7;

FIG. 9 is a top view of FIG. 7;

FIG. 10 is a close-up view of the system of FIG. 7; and

FIG. 11 shows details of a knife according to an embodiment of an aspect of the present disclosure.

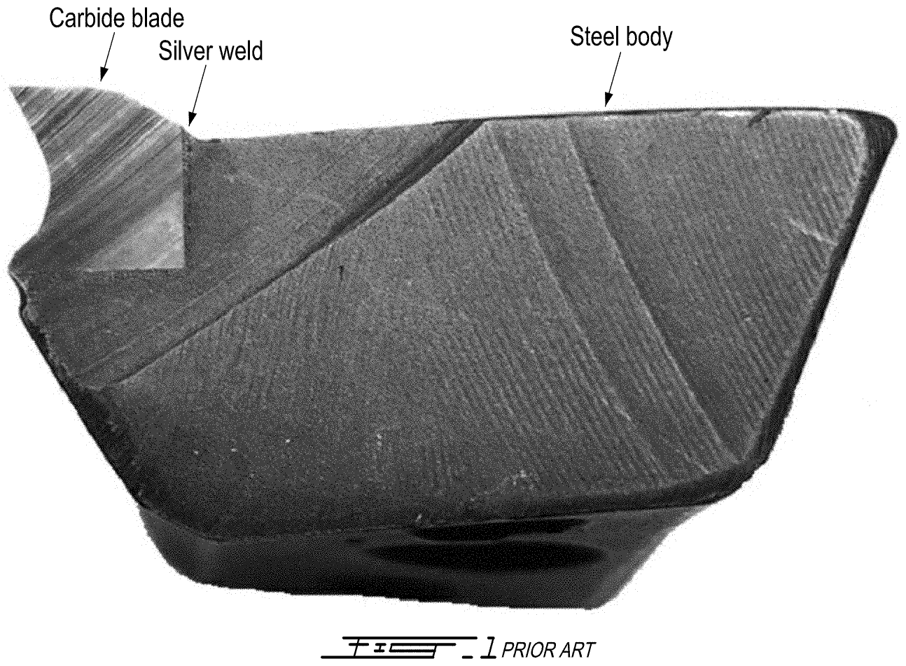

### DESCRIPTION OF ILLUSTRATIVE EMBODIMENTS

The present invention is illustrated in further details by the following non-limiting examples.

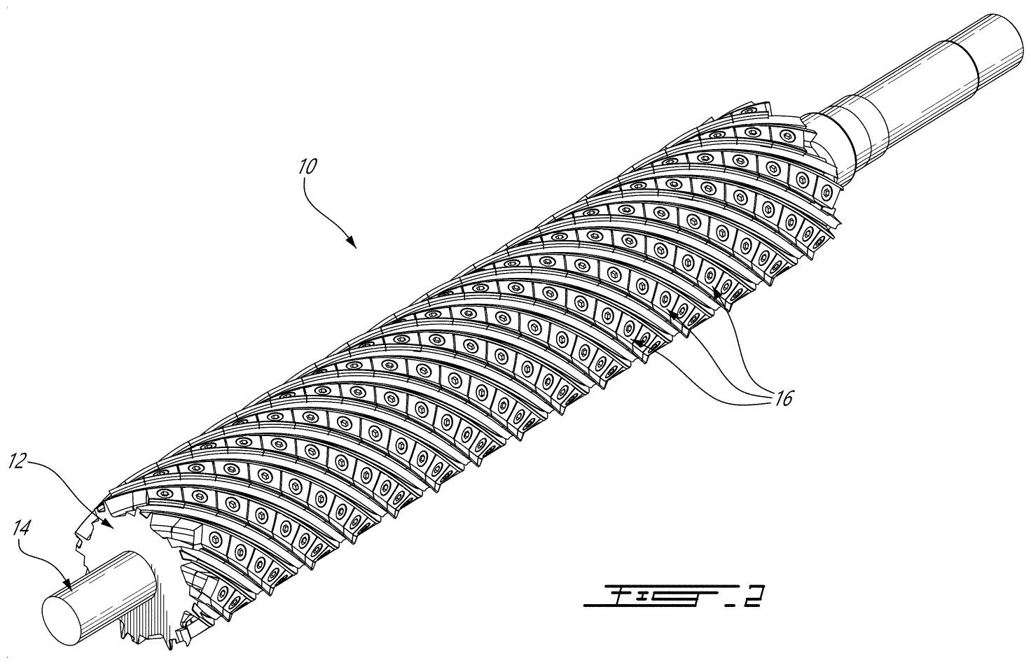

A cutting head 10 according to an embodiment of an aspect of the present disclosure as illustrated in FIGS. 2-4 for example comprises a cylindrical body 12 with rotation shafts 14 on each ends thereof.

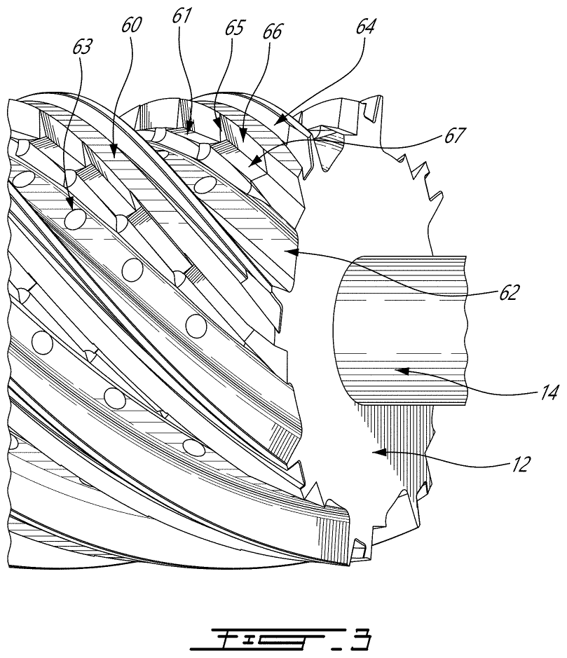

As best seen in FIG. 3, the surface of the cylindrical body 12 comprises an even number of adjacent main grooves 62 disposed on helices running along the length of the cylindrical body 12.

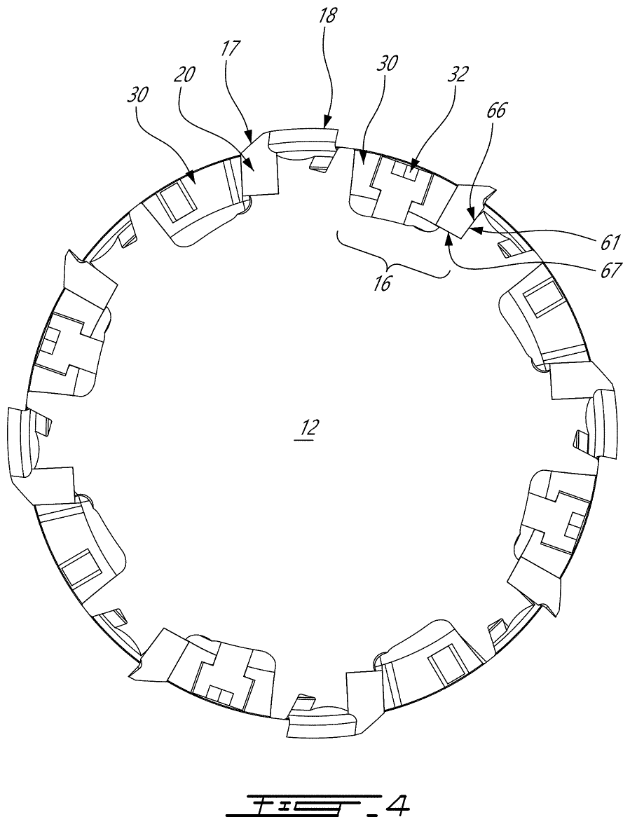

As shown in FIG. 4, each main groove 62 comprises cutting inserts 16. Each cutting insert 16 comprises a knife 17 which is removably secured in position relative to the main groove 62 by a clamp 30 secured to the cylindrical body 12 by a bolt 32.

The knife 17 is made in an abrasion resistant material, such as tungsten carbide or tool steel for example. The clamp 30 is made in a material of a ductility higher than the ductility of the material selected for the knife 17, for example, steel in case of a tungsten carbide knife 17.

The helices run along the longitudinal axis of cylindrical body 12 at an helicoidal angle θ selected in a range between about 35° and about 55°. An helicoidal angle of about 45° for example was found to yield clean, controlled and effective chip removal

A given cutting head may comprise hundreds of cutting inserts. For example, a thirty two inch-long cutting head having eight helices on the surface thereof may comprise about 300 cutting inserts 16. A wood planer typically comprises one or two cutting heads.

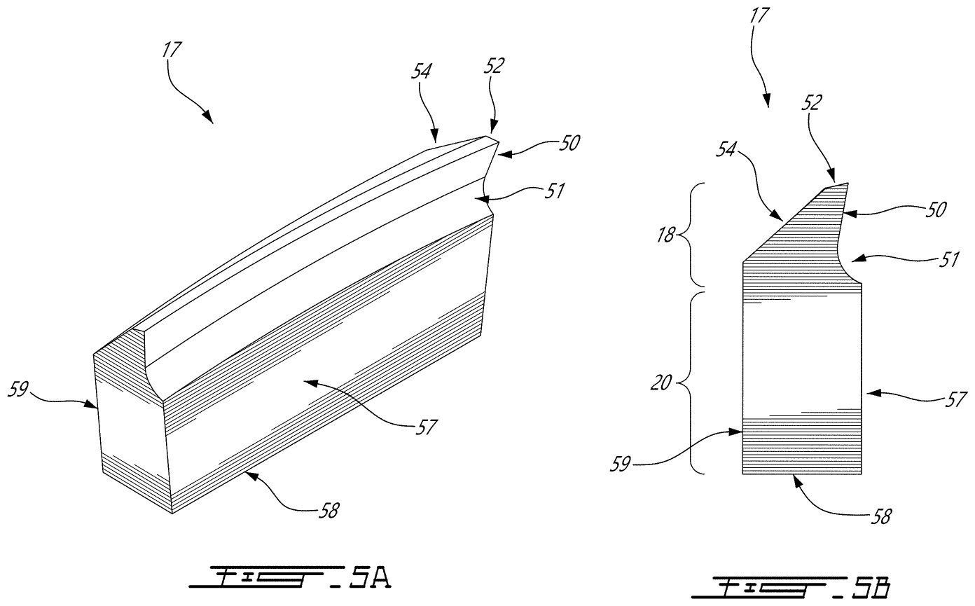

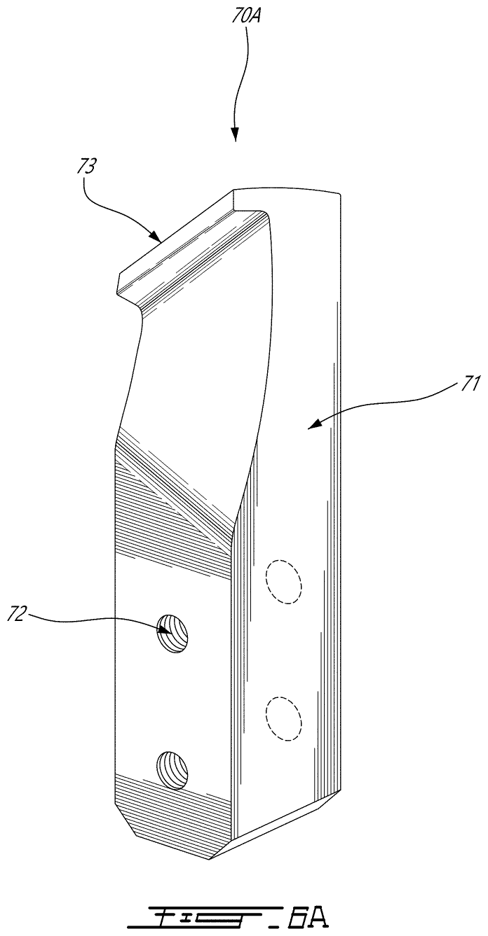

As shown in FIG. 5, a knife 17 according to an embodiment of an aspect of the present disclosure comprises a body 20 and a cutting edge 18. When the cutting insert 16 is mounted in the main groove 62 of the cutting head 10, the body 20 of the knife 17 is mounted within the main groove 62 and secured in position within the main groove 62 by the clamp 30 while the cutting edge 18 of the knife 17 protrudes from the surface of the cylindrical body 10.

The generally parallelepiped body of the body 20 of the knife 17 anchors the knife 17 in relation to surfaces 65, 66 and 67 of seats 61 of the main groove, thus supporting the cutting edge in an operating position from the surface of the cylindrical body 10 while providing resistance to breakage under impact as produced by a knot in a wood piece being machined during cutting operations. Such strong anchoring within the cylindrical body 12 of the cutting head 10 ensures a precise and mechanically strong positioning of the knife.

The cutting edge 18 comprises a front surface facing the wood piece being processed during cutting operation, and a backing surface 54, oriented away from any contact with the wood piece being processed. The cutting edge 18 is formed at the junction of a cutting angle 50 and a grinding angle 52.

The cutting angle 50 is selected and formed by grinding according to a target cutting edge 18 in view of target wood cutting applications, in a range between about 5° and about 35°, in relation to the essence and dryness of the wood to be processed. For example, in case of hard woods such as maple and oak for example, the cutting angle, also referred to as the angle of attack or the hook angle, may be selected in a range between about 5° and about 15°, while in case of softer woods such as pine for example, the angle of attack may be selected in a range between about 10° and about 35°. In case of woods with a moisture content in a range between about 6 and about 9%, the cutting angle 50 may be selected in a range between about 5° and about 15°, while for green wood, typically with higher moisture content, for example of about 10%, the cutting angle 50 may be selected in a range between about 10° and about 35°.

The grinding angle 52 is formed during sharpening as discussed hereinbelow. The grinding angle 52 is in the range between about 75° and about 85°.

On the front surface of the cutting edge 18 facing the wood piece being processed under operation, a hook 51 receives wood chips typically folded in a U shape on themselves rolling from the cutting angle 50.

The backing surface 54 of the cutting edge 18, oriented away from any contact with the wood piece being processed at an angle selected in a range between about 30° and about 60° relative to a radial direction (R) of the cylindrical body 12 when the knife 17 is locked into position in an operating mode of the cutting head in relation to the wood piece (FIG. 11). The backing surface 54 strengthens the cutting edge 18 of the knife 17.

The shape of the knife 17 combines machinability of the cutting edge 18 thereof and precise and secured insertion of the body 20 thereof within the main groove 62 in the cylindrical body 12 of the cutting head.

For mounting the knife to the cylindrical head, the clamp 30 is placed in abutment with the seats 61 within the main groove 62, thereby holding the knife 17 firmly against the bottom and side surfaces of the seats 61, the body 20 of the knife 17 forcing self-positioning of the knife 17 in the main groove 62 of the cutting head 10 in relation to the seats 61 of the main groove and the clamp 30. As the front surface 57; the bottom surface 58 and the side surface 59 of the knife 17 are pressed against the surfaces 66, 67 and 65 respectively of the seats 61, the knife 17 falls precisely into place within the main groove 62. Then the clamp 30 is locked into position within the main grove 62 by mean of a bolt 32 as described hereinabove for example, screwed in a bolt pattern 63, thereby locking the knife 17 into position within the main groove 62.

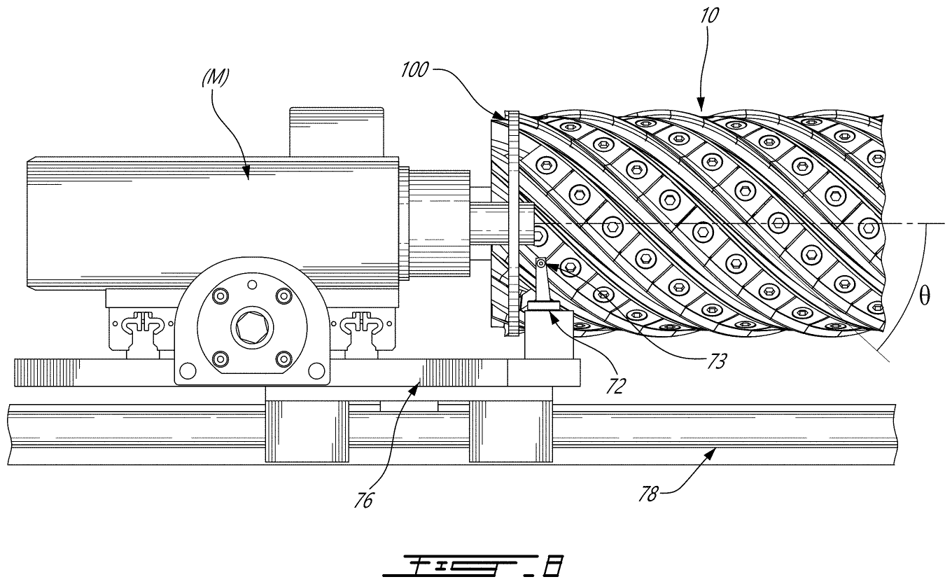

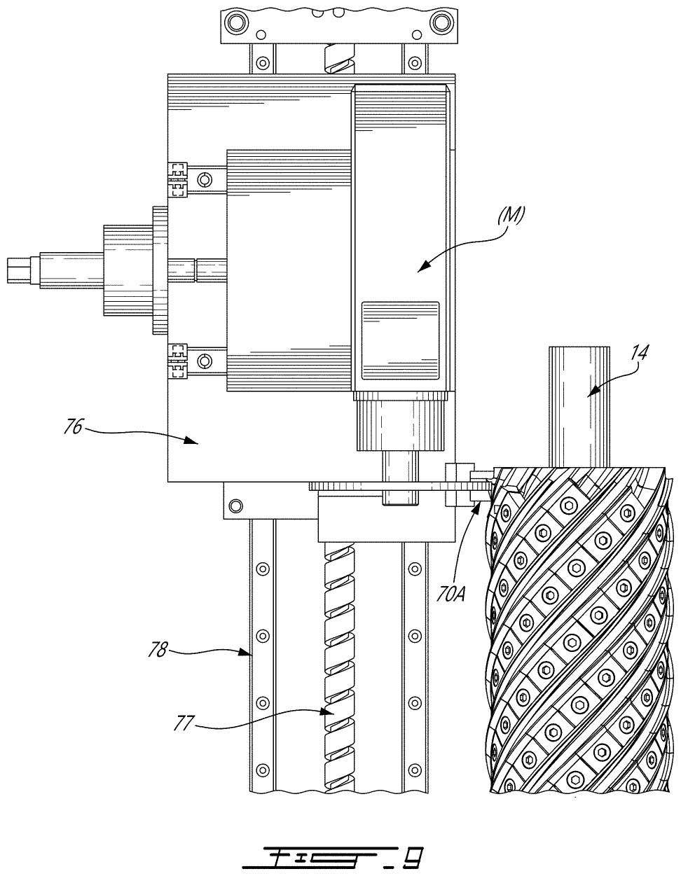

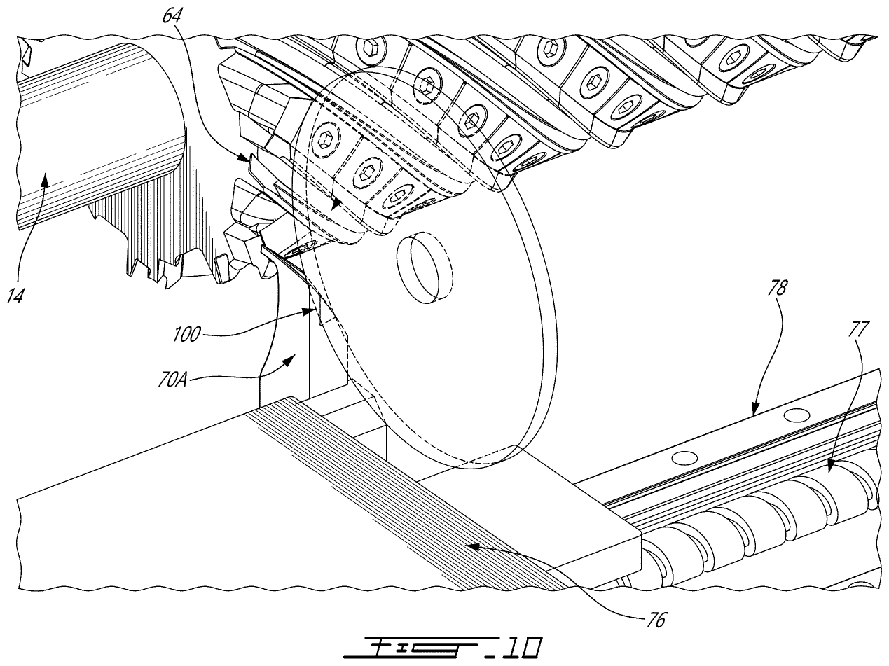

FIG. 4 shows spacing grooves 60 running adjacent the main grooves 62, for receiving wood chips as they are cut of, which are then directed to a dust collection system (not shown). Guiding grooves 64 discussed hereinbelow (FIG. 7), may be used to guide a sharpening guide, as described hereinbelow in relation to FIGS. 7-10.

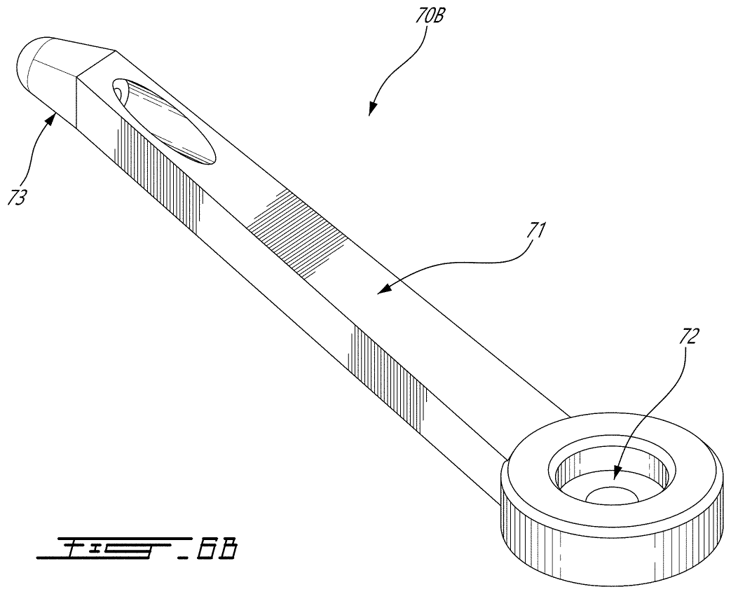

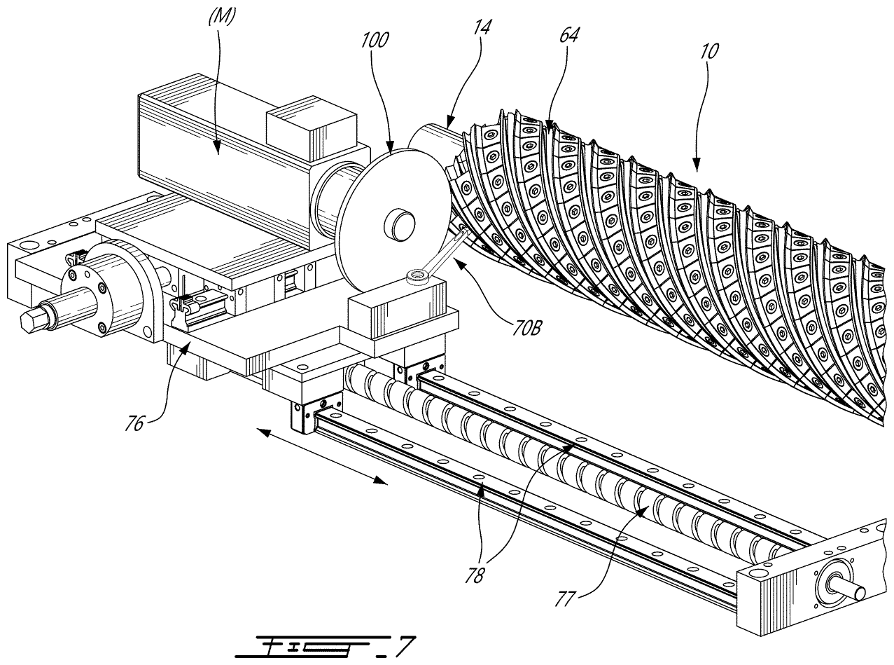

The sharpening guide 70A, 70B, illustrated in FIG. 6 for example, is a rigid body provided with a tip 73 of a shape selected to match the shape of the guiding groove 64.

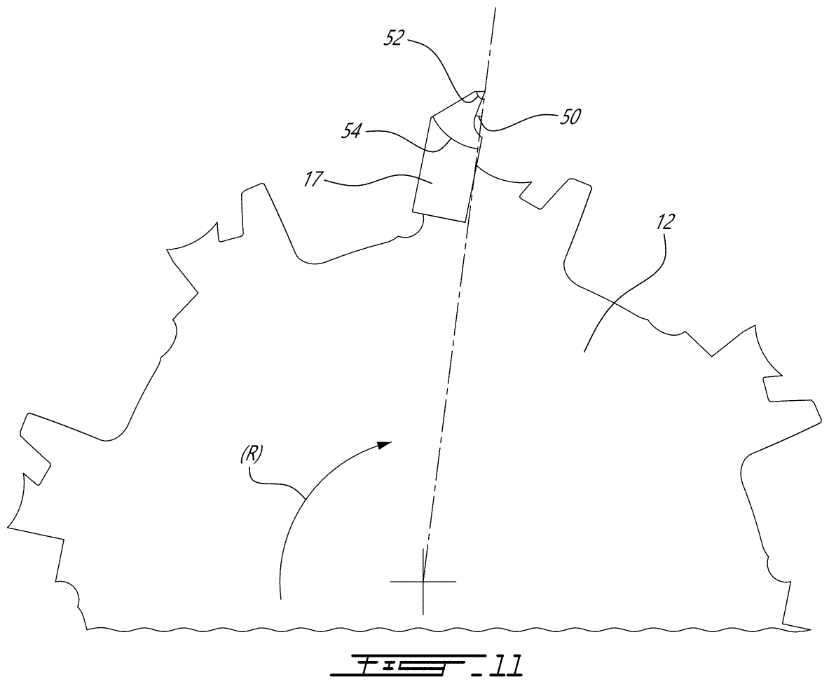

In a grinding system as shown in FIG. 7, rails 78 positioned parallel to the longitudinal axis of the cylindrical body 12 of the cylinder head support the push cart 76 for movement along a length of the rails 78. The push cart 76, shown driven by a lead screw 77, further supports a motorized grinding wheel 100. In FIG. 10, the grinding system is shown without motor (M), safety guards and other components for clarity.

The sharpening guide 70A is positioned relative to the cutting head 10 by engaging the tip 73 of the sharpening guide 70A within the guiding groove 64, with its body is connected to the push cart 76 by means of screws and connection holes 72 for example (FIGS. 6A and 10), thereby restraining the rotation of the cutting head 10 so that rotation of the cutting head 10 may be controlled by linear motion of the push cart 76 onto the guiding rails 78 (FIG. 6A). The sharpening guide 70B is positioned relative to the cutting head 10 by engaging the tip 73 thereof within the guiding groove 64, while securing a foot 72 thereof on the push cart (FIGS. 6B, 7 and 8).

Thus, the rotation of the cutting head 10 is restrained by engagement of the sharpening guide between the guiding groove of the cylinder cutting head and the driving unit of the rotation of the cylinder cutting head about its rotation shafts, by the foot of the sharpening guide configured for connection to the driving unit of the rotation of the cylinder cutting head and the tip thereof configured for engagement with the guiding groove of the cylinder cutting head. The rotation of the cutting head 10 is thus retrained by the sharpening guide so that rotation of the cutting head 10 is controlled by activating linear motion of the push cart 76 onto the guiding rails 78, to control the rotation of the cutting head 10 in order to precisely position the grinding wheel 100 relative to the cutting edge 18 of the cutting head 10, and displace the grinding wheel 100 relative to the helices of the cutting edge 18 of the knife 17. The sharpening guide maintains the relative positioning between the grinding wheel 100 and the cutting head, in both directions of the linear movement along the rails, thereby preventing backlash in case of interference by an operator or when the grinding wheel 100 hits discontinuities, such as notches for example, in the cutting edge 18 of the knives 17. As such events may cause a directional change in the linear movement for a short lapse of time, they may cause a shift in the relative positioning between the grinding wheel and the cutting head, which results in the rotation of the cutting head to falling out of sync. Backlash can cause imperfections on the cutting edges of the knives.

A precise grinding action is thus performed, and a constant grinding angle 52 is formed on all knifes 17 of the cutting head 10.

There is thus presented a sharpening method for a constant grinding angle on all knifes of the cutting head without backlash.

It has been found that the effective height of the cutting edge 18 of the knife 17, corresponding of the length of the cutting edge 18 of the knife 17 protruding from the surface of the cylindrical body 10, which can be used before the knife of the present disclosure needs to be removed and replaced by a new knife is increased by up to 50% compared to knifes in cutting heads currently used in the art, therefore providing higher tooling life and lower maintenance cost.

In operation, the spacing groove 60 running adjacent the main groove 62 receives wood chips as they are cut of, which are then directed to a dust collection system (not shown).

The present cutting tool may be used to process hard, soft, and green wood pieces at a speed up to 400 feet/minute for example, with affordable and replaceable cutting inserts.

Moreover, there is provided a method for sharpening the knifes directly onto the cutting head with precision, efficiency, reliability and repeatability. The sharpening method comprises guiding a sharpener so that the grinding angle on the knife is constant from a first end to the opposite end of each helix on the cutting head, from helix to helix and over successive sharpenings.

There is thus provided a helical cutting tool comprising cutting blade inserts, for woodworking machines such as planers.

The scope of the claims should not be limited by the embodiments set forth in the examples but should be given the broadest interpretation consistent with the description as a whole.

1. A cylindrical cutting head for a wood workpiece, comprising an even number of main grooves disposed on helices running on a length of a surface thereof, wherein each main groove comprises cutting inserts; each cutting insert comprising a knife removably locked in position in relation to the main groove by a clamp.

2. The cylindrical cutting head of claim 1, wherein an helicoidal angle of the helices is selected in a range between 35° and 55°.

3. The cylindrical cutting head of claim 1, wherein an helicoidal angle of the helices is 45°.

4. The cylindrical cutting head of claim 1, wherein said knife is made in an abrasion resistant material.

5. The cylindrical cutting head of claim 1, wherein said knife is made in one of: tungsten carbide and tool steel.

6. The cylindrical cutting head of claim 1, wherein said clamp is made in a material of a ductility higher than a ductility of a material selected for the knife.

7. The cylindrical cutting head of claim 1, wherein said knife comprises a body and a cutting edge, said body anchoring the knife in relation to surfaces within the main groove and said cutting edge protruding from the surface of the cylindrical body.

8. The cylindrical cutting head of claim 1, wherein said knife comprises a body and a cutting edge, said body anchoring the knife in relation to surfaces of the main groove and said cutting edge protruding from the surface of the cylindrical body, the cutting edge being formed at a junction of a cutting angle and a grinding angle, the cutting angle being selected in a range between 5° and 35° according to a target cutting edge, and said grinding angle having a value in a range between 75° and 85°.

9. The cylindrical cutting head of claim 1, wherein said knife comprises a body and a cutting edge, said body anchoring the knife within the main groove and said cutting edge protruding from the surface of the cylindrical body, the cutting edge being formed at a junction of a cutting angle and a grinding angle, the cutting angle being selected in a range between 5° and 15° according to a target cutting edge, and said grinding angle having a value in a range between 75° and 85°.

10. The cylindrical cutting head of claim 1, wherein said knife comprises a body and a cutting edge, said body anchoring the knife within the main groove and said cutting edge protruding from the surface of the cylindrical body, the cutting edge being formed at a junction of a cutting angle and a grinding angle, the cutting angle being selected in a range between° and about 35° according to a target cutting edge, and said grinding angle having a value in a range between 75° and 85°.

11. The cylindrical cutting head of claim 1, wherein said knife is anchored within the main groove in relation to surfaces of the main groove in relation to surfaces of the main groove; and said knife comprises a cutting edge protruding from the surface of the cylindrical body, said cutting edge comprising a surface facing the wood piece being processed during cutting operation by the cylindrical cutting head, and a backing surface oriented away from the wood piece being processed during cutting operation by the cylindrical cutting head.

12. The cylindrical cutting head of claim 1, wherein said knife comprises a body and a cutting edge, the body of the knife mounted within the main groove while the cutting edge of the knife protrudes from the surface of the cylindrical body, said body anchoring the knife within the main groove.

13. The cylindrical cutting head of claim 1, wherein said knife comprises a body and a cutting edge, the body of the knife mounted within the main groove while the cutting edge of the knife protrudes from the surface of the cylindrical body, said body being secured within the main groove by a clamp, the clamp being placed in abutment with first surfaces within the main groove, thereby holding the knife against second surfaces of the main groove, the clamp thereby positioning and locking the knife into position in relation to the main groove.

14. The cylindrical cutting head of claim 1, wherein said knife comprises a body and a cutting edge, the body of the knife mounted within the main groove while the cutting edge of the knife protrudes from the surface of the cylindrical body, said body being mounted within the main groove by a clamp, the clamp being placed in abutment with first surfaces within the main groove, thereby pressing surfaces of the knife against second surfaces of the main groove.

15. The cylindrical cutting head of claim 1, further comprising at least one guiding groove disposed on helices running parallely to the helices of the main groove along the length on the surface of the cylindrical cutting head, the guiding groove configured to guide a sharpening guide.

16. The cylindrical cutting head of claim 1, further comprising at least one guiding groove disposed on helices running parallely to the helices of the main groove along the length on the surface of the cylindrical cutting head, the guiding groove configured to guide a sharpening guide, the sharpening guide configured for engagement with the guiding groove on a first end thereof and for connection to a driving unit of the cutting head on a second end thereof.

17. A cutting insert for a cylindrical cutting head for a wood workpiece, comprising a knife and a clamp, wherein said knife is removably positioned and locked in position in relation to the cylindrical cutting head by a clamp.

18. The cutting insert of claim 17, wherein said knife comprises a body and a cutting edge, said body anchoring the knife in relation to the cylindrical head and said cutting edge protruding from a surface of the cylindrical head.

19. The cutting insert of claim 17, wherein said knife comprises a body and a cutting edge, said body being secured to the cylindrical head by a clamp placed in abutment with first surfaces of the cylinder head, said clamp positioning the knife against second surfaces of the cylinder head and locking the knife into position relative to the cylinder head.

20. The cutting insert of claim 17, wherein said knife comprises a body and a cutting edge, wherein said cutting edge is formed at a junction of a cutting angle and a grinding angle, the cutting angle being selected in a range between 5° and 35° according to a target cutting edge, and said grinding angle having a value in a range between 75° and 85°.
